(19) United States
(12) Patent Application Publication
(10) Pub. No.: US 2014/0162146 A1
(43) Pub. Date: Jun. 12, 2014

(54) ELECTRODE FOR LITHIUM-AIR BATTERY CONTAINING POROUS CARBON SUPPORTED BY CATALYST

(71) Applicant: Hyundai Motor Company, Seoul (KR)

(72) Inventor: Hee Yeon Ryu, Yongin (KR)

(21) Appl. No.: 13/920,414

(22) Filed: Jun. 18, 2013

(30) Foreign Application Priority Data
Dec. 12, 2012 (KR) 10-2012-0144769

(51) Int. Cl. H01M 4/86; H01M 4/90

(52) U.S. Cl. CPC H01M 4/8673; H01M 4/8605; H01M 4/9041; H01M 4/9091
USPC 429/405

(57) ABSTRACT

Disclosed is an electrode for a lithium-air battery containing porous carbons on which a metal catalyst is supported. In particular, the present invention relates to an electrode for a lithium-air battery with improved battery performance in which metal catalyst supported mesoporous carbons are mixed with heterogeneous conductive carbons as a conductive material, leading to an increase in dispersibility and reaction area.

### CROSS-REFERENCE TO RELATED APPLICATION

This application claims under 35 U.S.C. §119 (a) the benefit of Korean Patent Application No. 10-2012-0144769 filed Dec. 12, 2012, the entire contents of which are incorporated herein by reference.

### BACKGROUND

(a) Technical Field

The present disclosure relates to an electrode for a lithium-air battery containing catalyst-supported porous carbons. In particular, the present invention relates to an electrode for a lithium-air battery with improved battery performance through an increase in dispersibility and an enlargement of a reaction area which is achieved by mixing catalyst-supported porous carbons with heterogeneous conductive carbons as a conductive material.

(b) Background Art

Secondary batteries are different than primary batteries in that they are rechargeable and can be recycled by applying electric current. One type of secondary battery is a metal-air battery, which is made of a metal and air. Among such metal-air batteries, a lithium-air battery has the highest energy density. It has been reported that the energy per volume stored in the lithium-air battery is 10-fold higher than that of a lithium-ion battery. In addition, the lithium-air battery uses carbons instead of a metal such as nickel, manganese or cobalt which are commonly used in the lithium-ion battery. As such, lithium-air batteries are more cost competitive and echo-friendly than lithium-ion batteries.

A lithium-air battery has a structure in which lithium metal is used as an anode, a porous carbon is used as a cathode, and an electrolyte membrane is disposed therebetween. When oxygen is supplied to the porous carbon cathode, lithium is oxidized at the anode forming lithium ions and electrons. The thus formed lithium ions migrate across the electrolyte, and the electrons are transferred from the anode to the cathode, leading to the generation of energy.

The lithium-air battery has an extremely high energy density of 5000 Wh/kg or greater, which is equivalent to about 10-fold the energy density of conventional lithium ion batteries (theoretical energy density: 570 Wh/kg, actual level: ˜120 Wh/kg). Nonetheless, many attempts have been made to further improve energy density of the lithium-air battery.

In order to improve energy density of the lithium-air battery, there have been several studies on the type and content of a catalyst and dispersibility improvement thereof with respect to an air-electrode, and on the improvement of reactivity between the interface of air (oxygen), a conductive material and an electrolyte. Further studies have been conducted on increasing reactivity based on the type of electrolyte (aqueous/non-aqueous) used.

However, current lithium-air batteries are problematic in that they possess an extremely short life in charge and discharge states. Such short battery life is affected by the catalyst incorporated into the cathode and porosities of the conductive material. Further, because the anode is made of lithium metal, there is a risk of forming dendrites on the surface of the lithium metal through repeated charging and discharging, leading to a decrease in charge/discharge efficiency.

It has been reported that it is possible to improve the capacity and life performance of an air electrode by using manganese dioxide (MnO₂) as a catalyst instead of gold and platinum (T. Ogasawara, A. Debart, M. Holzapfel, P. Novak, P. G. Bruce, J. Am. Chem. Soc., 128(206): 1390-1393, 2006). Based on these reports, studies have been actively conducted on air-electrodes using manganese dioxide.

Recently, there have been studies on the regulation of catalyst content and dispersibility. In addition, as it has been found that the specific surface area and pore size of a conductive material used in an air-electrode have a significant influence on the capacity and life of a lithium-air battery, the studies on the use of a variety of conductive materials have been conducted.

Japanese Patent Laid-Open Publication No. 2007-0149636 describes a method for improving battery efficiency and performance of a lithium-air battery by using mesoporous carbon materials, in which a metal catalyst such as Mn is supported on porous carbon containing hetero atoms such as boron or phosphate, as a conductive material of an electrode.

Further, Korean Patent Application Publication No. 2010-86526 (Korean Patent No. 1074949) describes a method for manufacturing an electrode by mixing a porous carbon precursor and a metal precursor to obtain a carbon-metal precursor mixed material, carbonizing the carbon-metal precursor mixed material to obtain a carbon-metal composite material, and using the carbon-metal composite material as an electrode. Further described is a technique for supporting manganese metal as a catalyst on the carbon precursor.

Korean Patent Application Publication No. 2012-63925 describes a method for manufacturing a porous metal oxide containing uniformly dispersed catalysts by using a nanoporous hybrid compound, and a gas sensor comprising the same. Further described is a technique for uniformly dispersing a manganese dioxide catalyst in the porous metal oxide.

Korean Patent Application Publication No. 2012-81327 describes a nanocomposite for a lithium-air secondary battery in which carbon microspheres and a catalyst oxide are combined, and a method for the preparation thereof. According to the described method, a nanocomposite having a connected structure between the carbon microspheres and the catalyst oxide nanoparticles is prepared by using a metal oxide such as manganese.

The above-mentioned documents describe carbon materials having a structure in which a metal catalyst, such as manganese, is supported on porous carbon, and techniques for using the same as a cathode of a lithium-air battery so as to improve the efficiency of an air-electrode.

However, while the porous carbon on which a metal catalyst is supported is used, the improvement in conductivity of a lithium-air battery is insufficient. As such, the described materials provide limited improvement of battery efficiency and performance.

Thus, there is a need for lithium-air batteries that provide remarkably improved battery capacity and performance.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention has been made in an effort to solve the above-described problems associated with prior art.

In one aspect, the present invention provides an electrode for a lithium-air battery in which catalyst supported porous carbon is mixed with heterogeneous conductive carbon as a conductive material.

According to various embodiments, the present invention provides an electrode for a lithium-air battery in which comprises a first conductive material and a second conductive material, the first conductive material being supported by a metal catalyst. More particularly, according to a preferred embodiment, the present invention provides an electrode for a lithium-air battery comprising a first conductive material supported by a metal catalyst and composed of ordered mesoporous carbons, and a second conductive material composed of heterogeneous conductive carbons from the first conductive material. The first conductive material and the second conductive material are preferably mixed at a weight ratio of about 3˜50:97˜50 and composited.

According to another aspect, the present invention provides a lithium-air battery having remarkably improved battery capacity and performance, particularly wherein the lithium-air battery uses the described electrode material.

Other aspects and exemplary embodiments of the invention are discussed infra.

### EFFECT OF THE INVENTION

By using ordered mesoporous carbons with significantly wide specific surface area and pore size as a first conductive material, and mixing a heterogeneous conductive carbons having an influence on conductivity improvement of an air-electrode as a second conductive material, an electrode for a lithium-air battery is provided which demonstrates improved dispersibility and increased reaction area as compared with conventional lithium-air batteries. As such, battery capacity and charge/discharge efficiency is improved.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary diagram showing the structure of a first conductive material, which is metal catalyst-supported mesoporous carbons, according to one embodiment of the present invention. (a) and (b) of FIG. 1 represent different types the first conductive material on which the metal catalyst is supported.

FIG. 2 is an exemplary diagram showing the structure of a second conductive material, which is conductive carbons, according to one embodiment of the present invention. (a) of FIG. 1 represents the second conductive material in which a catalyst is not dispersed, and (b) of FIG. 2 represents the second conductive material in which a catalyst is dispersed.

FIG. 3 is an exemplary diagram showing the composite structure in which the first conductive material and second conductive material are mixed and composited according to one embodiment of the present invention.

Reference numerals set forth in the Drawings includes reference to the following elements as further discussed below:
1—mesoporous carbon
2, 2′—catalyst
3—heterogeneous conductive carbon

It should be understood that the appended drawings are not necessarily to scale, presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The present invention relates to an electrode for a lithium-air battery in which catalyst-supported mesoporous carbons and heterogeneous conductive carbons are composited.

According to various embodiments, the catalyst-supported mesoporous carbon which is used as a first conductive material is characterized in that a metal catalyst is supported thereon and composed of ordered mesoporous carbons.

According to various embodiments, the first conductive material may be ordered mesoporous carbons having a wide specific surface area and a large pore size. Preferably, during the preparation of the ordered mesoporous carbons, a metal catalyst is previously supported thereon, to thereby obtain a conductive material on which the metal catalyst is uniformly dispersed and supported.

Any conventional mesoporous carbon may suitably be used in the present invention. Preferably, the mesoporous carbon has a specific surface area ranging from about 800˜3000 m²/g and a pore size ranging from about 1˜50 nm, more preferably from about 1˜20 nm. The ordered mesoporous carbon in which nanopores are regularly arranged can be used as mesoporous carbon. For example, mesoporous carbon CMK-3, which comprises carbon nanorods with uniform diameters that are arranged in a honeycomb pattern, or carbon nanotube (CNT) can be used. As a representative example, CMK-3 is preferably used. The present invention preferably uses such ordered mesoporous carbon on which a metal catalyst is supported. The metal catalyst may include any conventional metal catalysts such as, for example, nano-sized gold, platinum, nickel and the like. Preferably, the metal catalyst is a manganese catalyst. The metal catalyst can be used in any amount, and is preferably used in an amount sufficient to fill the majority of pores of the mesoporous carbon depending on the intended purpose. In general, however, the metal catalyst can be used in an amount capable of at least partially filling the pores of the mesoporous carbon.

According to various embodiments, the method for supporting a metal catalyst on mesoporous carbon so as to form a first conductive material can be exemplified as follows: First, mesoporous carbon is treated with an acid, washed and dried. The thus dried mesoporous carbon is soaked in a metal oxide aqueous-based solvent as a metal catalyst precursor, followed by treating with an ultrasonic bath. After filtering and drying, a metal catalyst-supported porous carbon is prepared, which can be used as a first conductive material.

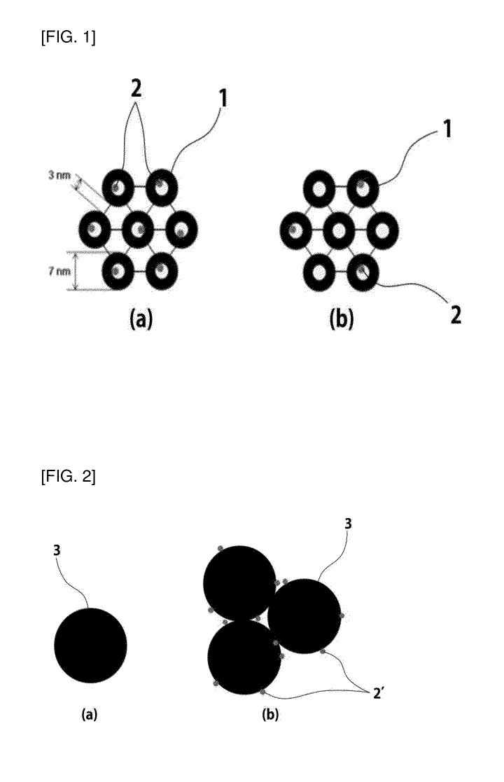

The first conductive material has a typical structure as shown in FIG. 1. (a) and (b) of FIG. 1 are representative examples illustrating the structure of the first conductive material being preferably applied to the present invention in which a metal catalyst (2) is supported on mesoporous carbon (1), respectively. (a) and (b) of FIG. 1 show two cases where the metal catalyst is supported on the first conductive material in a different manner. FIG. 1 illustrates a typical concept of the first conductive material which is a mesoporous carbon structure supported by a metal catalyst. As shown in FIG. 1, the first conductive material has a structure where the metal catalyst (2) is inserted into the pores of mesoporous carbon (1) which have a wide specific surface area, and are thus supported thereon.

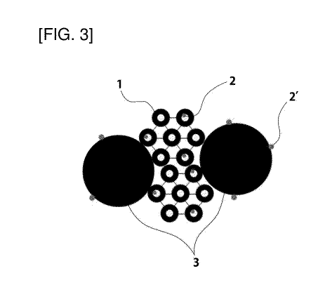

The present invention is characterized by combining the first conductive material with a second conductive material, which is made of heterogeneous conductive carbon, and compositing the same. Here, in order to achieve the effect of improving the performance of electrode materials, heterogeneous carbon which is different from the first conductive material is preferably used as a second conductive material. For instance, heterogeneous carbons may include an electroconductive carbon black material such as KETJENBLACK®, acetylene black, a conductive black such as VULCAN® XC-72 and the like. Considering conductivity and specific surface area, KETJENBLACK® having a specific surface area of about 500˜2000 m²/g is preferably used. Also, it is possible to use the second conductive material in a catalyst supported form or a non-supported form. When using the catalyst supported form, the second conductive material may be a material supported by any conventional metal catalyst. According to preferred embodiments, the second conductive material is supported by a manganese metal catalyst. In the case where a catalyst is supported on the second conductive material, this treatment (i.e. the process for supporting the catalyst on the second conductive material) is preferably carried out while combining the second conductive material with the first conductive material. When the metal catalyst is supported on the second conductive material while combining the two conductive materials, it can be expected to further improve the performance and efficiency of electrode materials. Further, the catalyst may be previously supported on the second conductive material during the preparation process thereof, or may alternatively be supported thereon during the combining process of the first and second conductive materials (i.e. the catalyst is either supported on the second conductive material when the second conductive material is prepared or when the second conductive material and the first conductive material are combined). FIG. 2 conceptually illustrates a structure of the second conductive material as conductive carbon according to a preferred embodiment of the present invention. (a) of FIG. 2 shows the case in which the catalysts are not dispersed, and (b) of FIG. 2 shows the case in which the catalysts (2′) are dispersed in conductive carbons (3). As illustrated in (a) of FIG. 2, the structure of the second conductive material provides a wide specific surface area which functions to improve conductivity. As illustrated in (b) of FIG. 2, the metal catalysts (2′) are dispersed in the second conductive material (3).

The first conductive material and second conductive material as described above are preferably mixed at a weight ratio of about 3˜50:97˜50, more preferably about 20˜40:80˜60 and the resulting mixture is composited, to thereby obtain a composite conductive material. If the amount of the second conductive material mixed therewith is excessive, there is a problem in that the catalysts are not uniformly dispersed. On the other hand, if the amount of the second conductive material is too small, it is difficult to balance supply and demand, and there is a problem of incurring high costs. Most preferably, the first conductive material and second conductive material are mixed at a weight ratio of about 30:70.

According to various embodiments, an electrode can be manufactured by mixing the first conductive material, second conductive material, a fluorine resin such as tetrafluoroethylene (PTFE) as a binder, and a solvent in the presence or absence of a metal catalyst, followed by making a slurry. At this time, the metal catalyst can be used in a manganese catalyst supported form by using a metal oxide, preferably manganese dioxide, as a precursor.

According to an embodiment of the present invention, the structure in which the first conductive material and second conductive material are combined is conceptually illustrated in FIG. 3. In particular, FIG. 3 shows the composite structure in which the first conductive material and second conductive material prepared according to the present invention are mixed and combined. As shown in FIG. 3, the composite preferably has a structure in which two kinds of heterogeneous carbon materials on which the catalysts are supported are combined and uniformly dispersed.

According to embodiments of the present invention, during the process of preparing ordered mesoporous carbon having a wide specific surface area and a large pore size, the metal catalysts are first supported on the mesoporous carbon, and the metal catalyst supported conductive material thus obtained is used as a first conductive material. A second conductive material is then mixed and combined with the first conductive material. The second conductive material is preferably made of heterogeneous conductive carbon that provides improved conductivity of an air-electrode. The resulting composited conductive material can be used for the manufacture of an electrode for a lithium-air battery.

The present invention has an advantage of improving conductivity by mixing the first conductive material, on which metal catalysts are supported, with the second conductive material and combining them through a dispersion process.

In addition, since the mesoporous carbon having a wide specific surface area and a large pore size is used itself as a first conductive material, and heterogeneous conductive carbon is combined therewith, it is possible to increase dispersibility and efficiency of a catalyst. As a result, performance and charge/discharge efficiency of a lithium-air battery is improved.

As compared with the prior art electrodes for a lithium-air battery that are manufactured by dispersing a metal catalyst in a conductive carbon having good conductivity and a wide specific surface area, the electrode for a lithium-air battery according to the present invention has several advantages in that its battery capacity is increased by at least about 10% and its charge capacity is improved.

In particular, performance of the battery electrode according to the present invention is improved due to the use of a combination of the first and second conductive materials. More particularly, performance is improved by combining a carbon material having a wide specific surface area and a large pore size as a first conductive material with a heterogeneous carbon having a wide specific surface area and a large pore size and which is different from the first conductive material and acts to improve conductivity as a second conductive material.

### EXAMPLES

The following examples illustrate the invention and are not intended to limit the same.

### Example 1

### Manufacture of a First Conductive Material

Mesoporous carbons used as a first conductive material were manufactured as follows: CMK-3 was prepared by using a silica template, subjected to acid treatment with H₂SO₄ at about 75° C. for 3 hours, washed with De-ionized water, and dried at 80° C. The thus prepared CMK-3 (1 g) was soaked in a KMnO₄ (0.138 M) aqueous-based solvent for about 3 hours, treated with an Ultrasonic bath (100 kHz, 600 W output power) for about 5 hours, filtered and dried (120° C., 10 hours), to thereby manufacture mesoporous carbons on which a nanomanganese dioxide catalyst was supported. The structure of the mesoporous carbon is shown in (b) of FIG. 1.

The mesoporous carbons of the first conductive material manufactured above had a specific surface area of about 800 m²/g and a pore size of about 2 nm.

### Example 2

### Manufacture of an Electrode for a Lithium-Air Battery

KETJENBLACK® was used as a heterogeneous conductive carbon for a second conductive material, and manganese dioxide (MnO₂) was used as a metal catalyst precursor. In order to mix the first conductive material prepared as metal supported mesoporous carbon in Example 1 with KETJENBLACK® as a second conductive material, the first conductive material (Mn catalyst supported CMK-3), KETJENBLACK® and MnO₂ were mixed at a weight ratio of 20 wt %:79 wt %:1 wt % based on total weight of the mixture. At this time, PTFE as a binder and an NMP (N-methyl-2-pyrrolidone)(solid content: 20 wt %) solvent were mixed therewith. The resulting mixture was treated in a planetary mill at 300 rpm for 3 hours, to thereby prepare a composite slurry. The thus prepared slurry was coated on a nickel mesh, and dried at 100° C. for 30 min, to thereby manufacture an electrode for a lithium-air battery. The structure of the electrode is shown in FIG. 3.

### Example 3

### Manufacture of an Electrode for a Lithium-Air Battery

An electrode for a lithium-air battery was manufactured according to the same method as described in Example 2 except that mesoporous carbon as a first conductive material, KETJENBLACK® as a second conductive material and MnO₂ were mixed at a weight ratio of 30 wt %:69 wt %:1 wt % based on total weight of the mixture, and PTFE as a binder and an NMP solvent (solid content: 15 wt. %) were mixed therewith.

### Comparative Example 1

### Manufacture of an Electrode

An electrode for a lithium-air battery was manufactured according to the same method as described in Example 2 except that an electron material being composed of the first conductive material which was prepared in Example 1 was used in 100 wt % based on total weight of the electron material.

### Comparative Example 1

### Manufacture of an Electrode

An electrode for a lithium-air battery was manufactured by mixing KETJENBLACK® as a second conductive material with MnO₂ and a binder (PTFE and NMP solvent (solid content: 15 wt. %) at a weight ratio of 60 wt %:20 wt %:20 wt % based on the total weight of the electrode.

### Test Example

Lithium-air batteries were manufactured by using each electrode prepared in Example 2, Comparative Examples 1 and 2 and LiPF₆ in PC (propylene carbonate)/DEC (ditehylene carbonate) as a electrolyte, and then their electrode performance was assessed.

For this, the lithium-air battery was subjected to one cycle of discharging and charging, and its efficiency was represented as a charge amount/discharge amount (%). The results of assessing electrode performance are shown in Table 1.

TABLE 1

| | | | Comparative | Comparative |
|---|---|---|---|---|
| Test category | Example 2 | Example 3 | Example 1 | Example 2 |
| Discharge amount | 6200 | 6800 | 4820 | 5200 |
| (mAh/g) | | | | |
| Charge amount | 7120 | 7100 | 5980 | 6830 |
| (mAh/g) | | | | |
| Charge/discharge | 109 | 104 | 124 | 131 |
| efficiency (%) | | | | |

 A charge/discharge efficiency is close to 100%, it is considered to be excellent.

As can be seen from the above results, it has been found that the lithium-air battery according to the present invention (Examples 2 and 3) demonstrated significantly improved battery performance as compared with those of Comparative Examples 1 and 2.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An electrode for a lithium-air battery comprising: a first conductive material supported by a metal catalyst and composed of ordered mesoporous carbons; and a second conductive material composed of a heterogeneous conductive carbon different from the first conductive material, wherein the first conductive material and the second conductive material are mixed at a weight ratio of about 3˜50:97˜50.

2. The electrode for a lithium-air battery according to claim 1, wherein the metal catalyst is at least one of nano-sized gold, platinum, manganese and nickel.

3. The electrode for a lithium-air battery according to claim 2, wherein the metal catalyst is manganese.

4. The electrode for a lithium-air battery according to claim 1, wherein the mesoporous carbon has a specific surface area of about 800˜3000 m²/g and a pore size of about 1˜20 nm.

5. The electrode for a lithium-air battery according to claim 1, wherein the heterogeneous conductive carbon of the second conductive material is KETJENBLACK®.

6. The electrode for a lithium-air battery according to claim 1, wherein the first conductive material and second conductive material are mixed at a weight ratio of about 20˜40:80˜60.

7. The electrode for a lithium-air battery according to claim 1, wherein the second conductive material is supported by a metal catalyst.

8. The electrode for a lithium-air battery according to claim 7, wherein the metal catalyst supporting the second conductive material is at least one of nano-sized gold, platinum, manganese and nickel.

9. The electrode for a lithium-air battery according to claim 8, wherein the metal catalyst is manganese.
